(19) United States
(12) Patent Application Publication
(10) Pub. No.: US 2024/0239259 A1
(43) Pub. Date: Jul. 18, 2024

(54) FREIGHT TRANSPORTATION TIE-DOWN SYSTEM AND METHOD

(71) Applicant: Henry Myers, Lake Charles, LA (US)

(72) Inventor: Henry Myers, Lake Charles, LA (US)

(21) Appl. No.: 18/098,509

(22) Filed: Jan. 18, 2023

(51) Int. Cl. B60P 7/13; B62D 33/06

(52) U.S. Cl. CPC B60P 7/13; B62D 33/06

(57) ABSTRACT

A freight transportation tie-down system and method for increasing strength and durability of the strap includes a vehicle and a freight being carried by the vehicle. A ratchet is coupled to the vehicle and a winch strap is coupled to the ratchet. The winch strap comprises a plurality of metal wires.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tie-down straps and more particularly pertains to a new tie-down strap for increasing strength and durability of the strap.

### (2) Description of Related Art Including Information Disclosed Under 37 CFR 1.97 and 1.98

The prior art relates to tie-down straps and includes a variety of tie-down straps configured to secure a freight to a transportation vehicle. Known prior art does not include a tie-down strap comprising a plurality of metal wires being engageable with a ratchet to facilitate securing a freight to a transportation vehicle.

### BRIEF SUMMARY OF THE INVENTION

An embodiment of the disclosure meets the needs presented above by generally comprising a vehicle and a freight being carried by the vehicle. A ratchet is coupled to the vehicle and a winch strap is couplable to the ratchet. The winch strap comprises a plurality of metal wires.

Another embodiment of the disclosure comprises a method including the steps of providing a winch strap and coupling the winch strap to a ratchet. An end of the winch strap extends from the ratchet to form a portion of the winch strap from the end to the ratchet. The portion of the winch strap abuts to an exterior of a freight and the end of the winch strap couples to a trailer thereafter. A gear of a center rod of the ratchet is rotated in a first direction to tighten the portion of the winch strap to the freight.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a freight transportation tie-down system according to an embodiment of the disclosure.

FIG. 2 is a side view of an embodiment of the disclosure.

FIG. 3 is a rear view of an embodiment of the disclosure.

FIG. 4 is a cross-sectional view of an embodiment of the disclosure taken along Line 4-4 of FIG. 2.

FIG. 5 is a cross-sectional view of an embodiment of the disclosure taken along Line 5-5 of FIG. 3.

FIG. 6 is an in-use view of an embodiment of the disclosure.

FIG. 7 is an in-use view of an embodiment of the disclosure.

FIG. 8 is a side view of an embodiment of the disclosure.

FIG. 9 is exploded view of an embodiment of the disclosure.

### DETAILED DESCRIPTION OF THE INVENTION

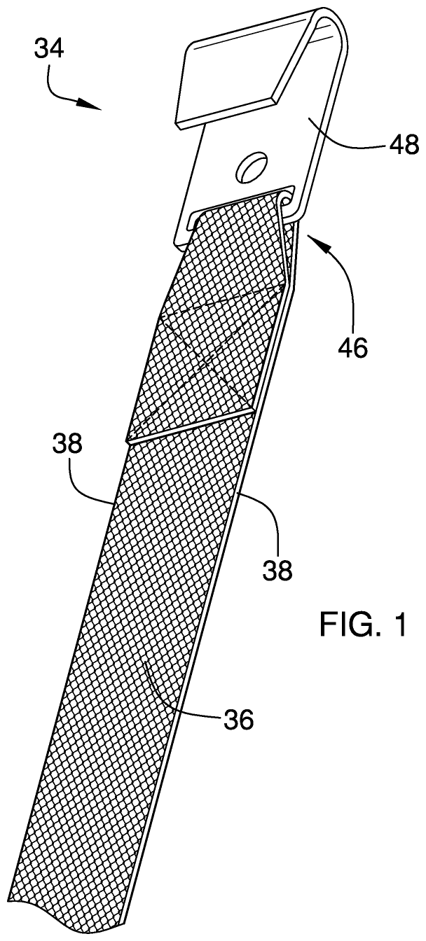

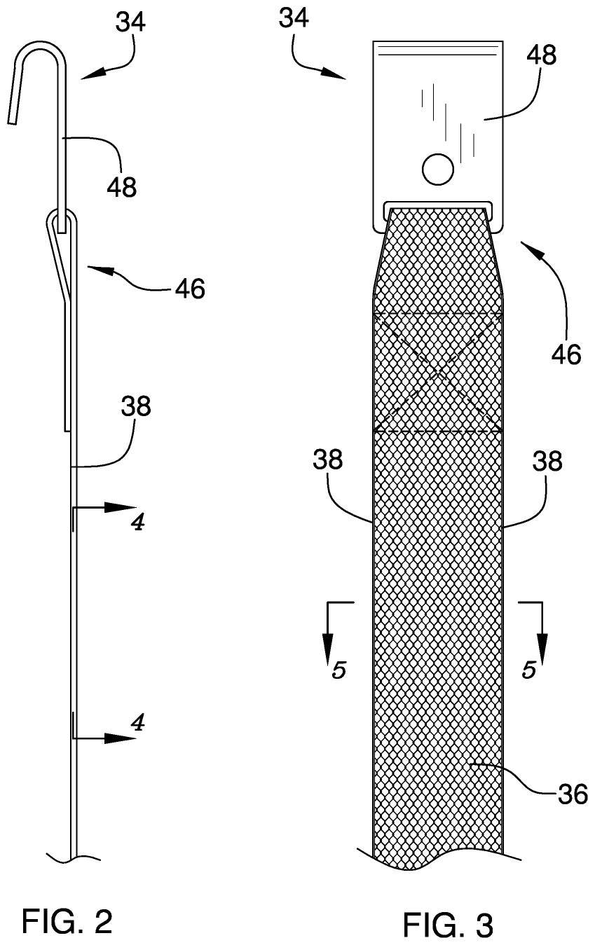

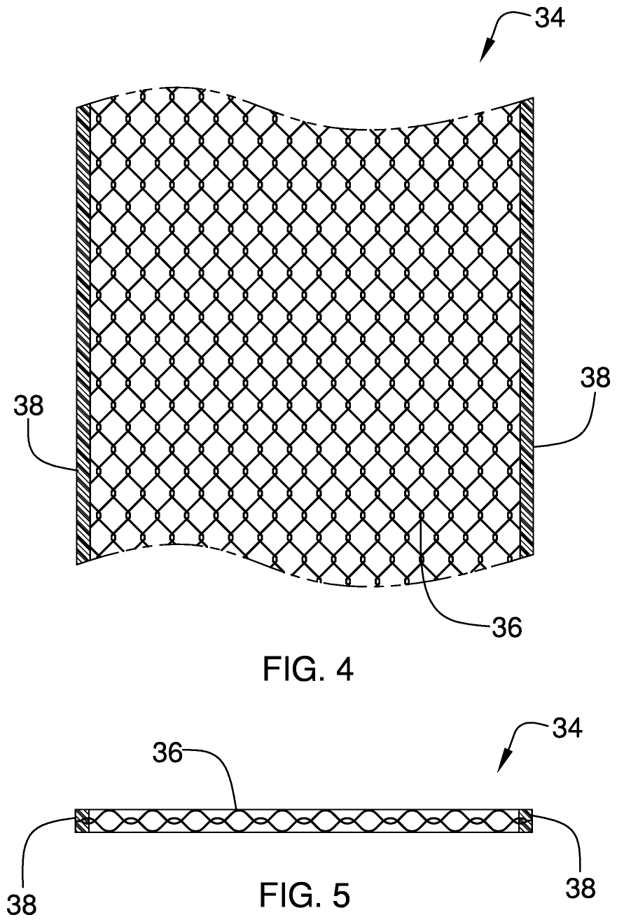

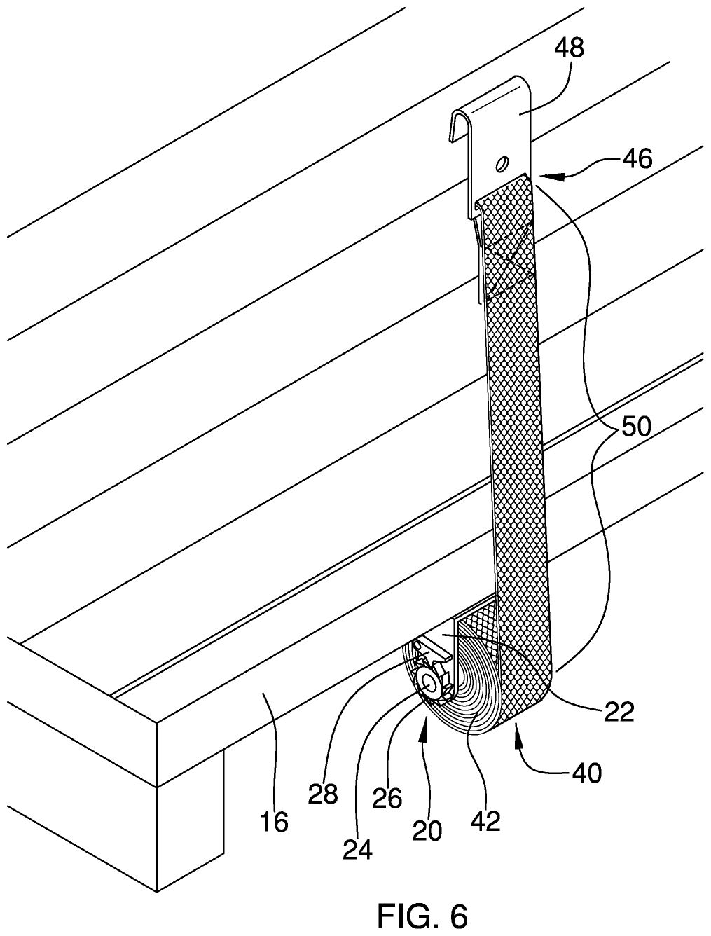

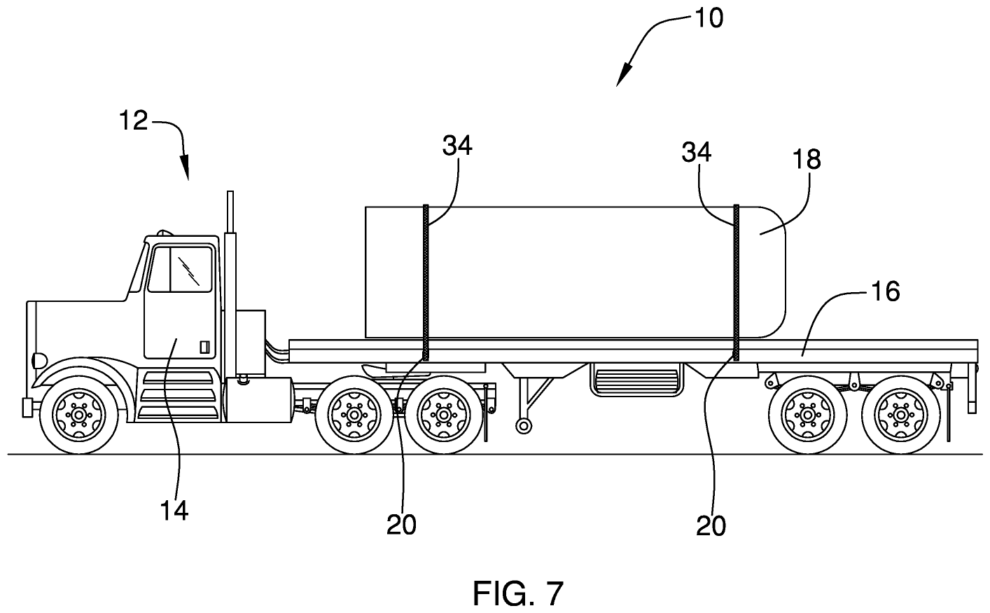

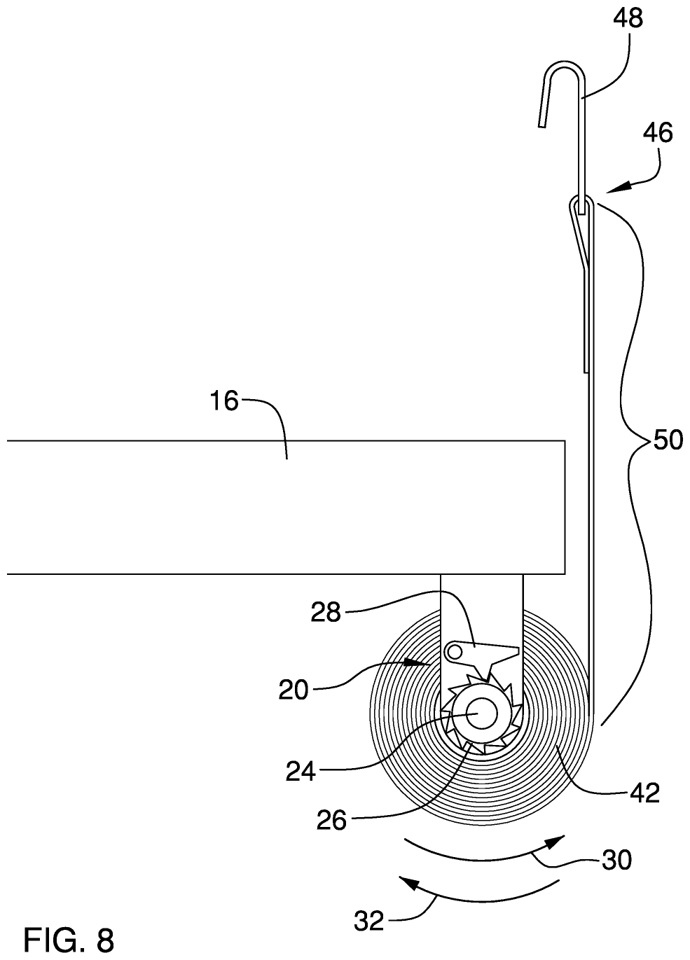

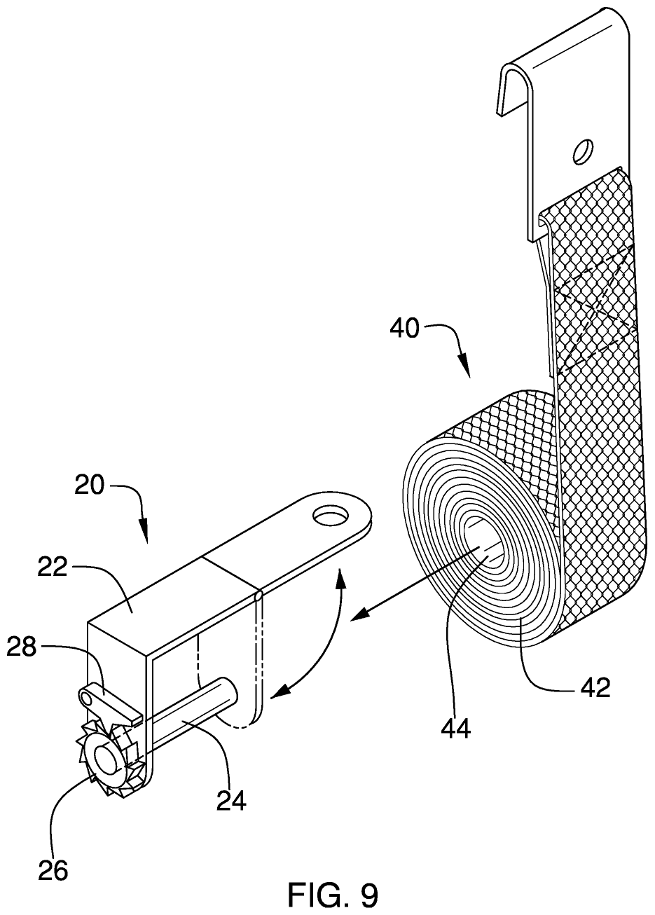

With reference now to the drawings, and in particular to FIGS. 1 through 9 thereof, a new tie-down strap embodying the principles and concepts of an embodiment of the disclosure and generally designated by the reference numeral 10 will be described.

As best illustrated in FIGS. 1 through 9, the freight transportation tie-down system 10 generally comprises a vehicle 12. The vehicle 12 normally comprises a tractor trailer including a cab 14 and a trailer 16 being coupled to the cab 14 wherein the trailer 16 is pulled by the cab 14. The vehicle 12 may comprise a train, a ship, an aircraft, or any other conventional vehicle 12 for cargo transportation. A freight 18 is carried by the vehicle 12 and typically comprises a container being removably positionable upon the trailer 16 of the tractor trailer. The container may be a rectangular housing used to store cargo.

A ratchet 20 is coupled to the vehicle 12 and is normally positioned on an underside of the trailer 16. The ratchet 20 includes a housing 22 and has a center rod 24 rotatably coupled thereto. A gear 26 is mechanically coupled to the center rod 24 wherein the gear 26 in a first direction 30 to rotate the center rod 24 in the first direction 30. A pawl 28 is mechanically engaged with the gear 26 to inhibit the gear 26 from rotating the center rod 24 in a second direction 32.

A winch strap 34 is couplable to the ratchet 20. The winch strap 34 comprises a plurality of metal wires 36 positioned in a cross woven pattern. The winch strap 34 has a pair of side edges 38 and each side edge 38 of the pair of side edges 38 may comprise a fabric material. The winch strap 34 is normally positioned in a rolled position to define a roll of winch strap 40. The roll of winch strap 40 has a pair of side surfaces 42 and an opening 44 is positioned in a center of one of the pair of side surfaces 42 and extends therethrough. The roll of winch strap 40 is removably receivable of the center rod 24 of the ratchet 20 within the opening 44 wherein the roll of winch strap 40 is securable to the ratchet 20. An end 46 of the winch strap 34 has a fastener 48 releasably fastening to the trailer 16. The fastener 48 typically comprises a hook or any other conventional fastener.

In another embodiment, the winch strap 34 is provided and coupled to the ratchet 20 thereafter. The end 46 of the winch strap 34 is extended from the ratchet 20 to form a portion 50 of the winch strap 34 from the end 46 to the ratchet 20. The portion 50 of the winch strap 34 abuts to an exterior of the freight 18 positioned on the trailer 16 of the tractor trailer. The end 46 of the winch strap 34 is coupled to the trailer 16 thereafter and the gear 26 of the center rod 24 of the ratchet 20 is rotated in the first direction 30 to tighten the portion of the winch strap 34 to the freight 18 wherein the winch strap 34 secures the freight 18 to the trailer 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An enhanced shipping transportation system comprising:
a vehicle;
a freight being carried by said vehicle;
a ratchet being coupled to said vehicle; and
a winch strap being couplable to said ratchet, said winch strap comprising a plurality of metal wires.

2. The enhanced shipping transportation system of claim 1, wherein said vehicle comprises a tractor trailer, said tractor trailer including a cab and a trailer being coupled to said cab wherein said trailer is pulled by said cab.

3. The enhanced shipping transportation system of claim 2, wherein said freight comprises a container being removably positionable upon said trailer of said tractor trailer.

4. The enhanced shipping transportation system of claim 3, wherein said ratchet is positioned on an underside of said trailer.

5. The enhanced shipping transportation system of claim 1, wherein said ratchet including a housing and having a center rod rotatably coupled thereto, a gear being mechanically coupled to said rod, wherein said gear rotates in a first direction to rotate said rod in said first direction, a pawl being mechanically engaged with said gear to inhibit said gear from rotating in a second direction.

6. The enhanced shipping transportation system of claim 1, wherein said plurality of metal wires is positioned in a cross woven pattern, said winch strap having a pair of side edges, each side edge of said pair of side edges comprising a fabric material.

7. The enhanced shipping transportation system of claim 5, wherein said winch strap is positioned in a rolled position to define a roll of winch strap, said roll of winch strap having a pair of side surfaces, an opening being positioned in a center of one of said pair of side surfaces and extending therethrough, said roll of winch strap being removably receivable of said center rod within said opening, wherein said roll of winch strap is securable to said ratchet.

8. The enhanced shipping transportation system of claim 3, wherein an end of said winch strap has a fastener releasably fastening to said trailer, said fastener comprising a hook.

9. An enhanced shipping transportation system comprising:
a vehicle, said vehicle comprising a tractor trailer, said tractor trailer including a cab and a trailer being coupled to said cab wherein said trailer is pulled by said cab;
a freight being carried by said vehicle, said freight comprising a container being removably positionable upon said trailer of said tractor trailer;
a ratchet being coupled to said vehicle, said ratchet being positioned on an underside of said trailer, said ratchet including a housing and having a center rod rotatably coupled thereto, a gear being mechanically coupled to said rod, wherein said gear rotates in a first direction to rotate said rod in said first direction, a pawl being mechanically engaged with said gear to inhibit said gear from rotating in a second direction; and
a winch strap being couplable to said ratchet, said winch strap comprising a plurality of metal wires, said plurality of metal wires being positioned in a cross woven pattern, said winch strap having a pair of side edges, each side edge of said pair of side edges comprising a fabric material, said winch strap being positioned in a rolled position to define a roll of winch strap, said roll of winch strap having a pair of side surfaces, an opening being positioned in a center of one of said pair of side surfaces and extending therethrough, said roll of winch strap being removably receivable of said center rod within said opening, wherein said roll of winch strap is securable to said ratchet, an end of said winch strap having a fastener releasably fastening to said trailer, said fastener comprising a hook.

10. A method for securing down a freight comprising the steps of:
providing a winch strap;
coupling said winch strap to a ratchet;
extending an end of said winch strap from said ratchet to form a portion of said winch strap from said end to said ratchet;
abutting said portion of said winch strap to an exterior of a freight;
coupling said end of said winch strap to a trailer; and
rotating a gear of a center rod of said ratchet in a first direction to tighten said portion of said winch strap to said freight.
